(19) United States
(12) Patent Application Publication
(10) Pub. No.: US 2025/0207551 A1
(43) Pub. Date: Jun. 26, 2025

(54) INJECTOR NOZZLE

(71) Applicant: PHINIA DELPHI LUXEMBOURG SARL, Belvaux (LU)

(72) Inventors: Michael Peter COOKE, Kent (GB); Jonathan Nicholas WRAY, Gloucestershire (GB)

(21) Appl. No.: 18/844,765

(22) PCT Filed: Mar. 8, 2023
(86) PCT No.: PCT/EP2023/055932

§ 371 Date: Sep. 6, 2024

(30) Foreign Application Priority Data
Mar. 8, 2022 (GB) 2203220.5

(51) Int. Cl. F02M 61/18; F02M 21/02; F02M 61/06

(52) U.S. Cl. CPC F02M 61/182; F02M 21/0206; F02M 21/0248; F02M 61/06

(57) ABSTRACT

An injector nozzle of a fuel injector for an internal combustion engine comprises a valve needle, and a nozzle body extending along a longitudinal axis from a tip, at a proximal end, to an opposing distal end for connection to the fuel injector. The nozzle body is provided with a bore within which the valve needle is moveable; and a valve seat defined at a proximal end of the bore and transitioning into a sac that defines a sac volume. The valve needle is moveable relative to the valve seat to control fuel delivery through a first set of nozzle outlets and a second set of nozzle outlets. The valve needle includes a seat region and a fuel guiding region extending proximally from the seat region.

### FIELD OF THE INVENTION

The invention relates to an injector nozzle for use in a fuel injection system of an internal combustion engine. Aspects of the invention relate to an injector nozzle and to a fuel injector for an internal combustion engine.

### BACKGROUND TO THE INVENTION

Fuel injectors are provided in fuel injection systems to inject fuel at high pressure into the associated combustion cylinders. Each fuel injector includes an injector nozzle having a valve needle, which is typically operated by means of an actuator to move towards and away from a valve seat. In this manner, the valve needle may be moved to control the fuel delivery into the combustion cylinder through one or more spray holes, or nozzle outlets, at the tip of the injector nozzle.

However, when a gaseous fuel is used, such as hydrogen gas, it is difficult to deliver enough fuel into the combustion cylinder in the time available and to distribute the fuel evenly around that cylinder. In part, this is because the available injection pressure may vary in dependence on the pressure remaining in the fuel tank, which reduces as more fuel is used.

It is therefore desirable to provide an injector nozzle designed to have a high flow area for operation at low pressure, whilst trying to minimize the diameter of the valve seat and thereby minimise the actuation forces required to operate the fuel injector at high pressure.

It is against this background that the invention has been devised.

### SUMMARY OF THE INVENTION

According to an aspect of the invention there is provided an injector nozzle of a fuel injector for delivering gaseous fuel to an internal combustion engine. The injector nozzle comprises: a valve needle; and a nozzle body extending along a longitudinal axis from a tip, at a proximal end, to an opposing distal end for connection to the fuel injector, the nozzle body being provided with: a bore within which the valve needle is moveable; and a valve seat defined at a proximal end of the bore and transitioning into a sac that defines a sac volume. The valve needle is moveable relative to the valve seat to control fuel delivery through a first set of nozzle outlets and a second set of nozzle outlets, the first set of nozzle outlets defining a first row of openings in a wall of the sac and the second set of nozzle outlets defining a second row of openings in the sac wall, the first row of openings being arranged distally from the second row of openings along the longitudinal axis. Said valve needle includes a seat region and a fuel guiding region extending proximally from the seat region such that: in a non-injecting state, the seat region seats against the valve seat and the fuel guiding region extends into the sac volume, and, in an injecting state, the seat region is unseated from the valve seat and the fuel guiding region interacts with the bore to guide fuel from the valve seat to at least one of the first and second sets of nozzle outlets.

With this arrangement the first and second sets of nozzle outlets can be distributed around the sac in a balanced manner, collectively providing a large flow area into the combustion chamber, and the fuel guiding region acts to redirect, or turn, fuel flowing past the valve seat toward the nozzle outlets, thereby maximising the fuel delivery, and distributing fuel evenly around the combustion cylinder. The diameter of the valve seat can therefore be minimised, in turn reducing the actuation forces required to operate the fuel injector at high pressure.

Optionally, the second row of openings may be arranged circumferentially between adjacent openings of the first row of openings. In this manner, the flow area into the combustion chamber can be maximised. Optionally, the second row of openings may be smaller, and/or fewer in number, than the first row of openings. In this manner, the second row of openings can be arranged radially closer to the longitudinal axis without overlapping.

The sac may, for example, comprise a first sac portion and a second sac portion extending proximally from the first sac portion; the first row of openings being defined in a wall of the first sac portion and the second row of openings being defined in a wall of the second sac portion. In this manner, the first row of openings may be arranged in an upper or distal sac portion, at a greater radial distance from the longitudinal axis and the second row of openings may be arranged in a lower or proximal sac portion. The first and second sac portion may be distinguished by having different shapes, curvatures and or gradients for example.

Optionally, the first sac portion has a frusto-conical shape and the second sac portion has a spherical shape, a spheroidal shape, or an ellipsoidal shape. This arrangement ensures that the size of the sac, and in turn, the diameter of the valve seat, may be minimised whilst ensuring adequate supply of fuel to the combustion chamber. Optionally, the first and second sac portions may define a spherical shape, a spheroidal shape, or an ellipsoidal shape.

In an example, distal edges of the openings of the first row of openings may be arranged in planar alignment toward a distal end of the first sac portion. This shape allows the size of the sac to be minimised.

In an example, the second set of nozzle outlets may extend from the second row of openings along respective outlet axes that intersect at a common point in the sac volume. Optionally, the intersection point may be coincident with a centre of curvature of the second sac portion. This arrangement can ensure that the second set of nozzle outlets have similar lengths, which is advantageous for balancing the flow of fuel between the outlets.

Optionally, the fuel guiding region comprises a first section having the shape of a neiloidic frustum converging towards a proximal end and having an outer surface defining a curved profile. The shape of the fuel guiding region can therefore be configured to advantageously interact with the bore of the nozzle body to turn the flow of fuel and encourage respective flow paths to the first set of nozzle outlets and the second set of nozzle outlets.

Optionally, the fuel guiding region is shaped so as to interact with the bore in the injecting state such that: below a threshold needle lift height, the fuel guiding region biases fuel flow towards the second row of openings; and, at or above the threshold needle lift height, the fuel guiding region negates the bias, such that fuel flows towards both the first and second row of openings. For example, the threshold needle lift height may be less than 50% of the maximum lift height, preferably, less than 35% of the maximum lift height, or even less than or equal to 15% of the maximum lift height.

Optionally, the first section of the fuel guiding region is arranged distally of the first sac portion to guide fuel into the first and second sac portions when the valve needle is lifted above the threshold needle lift height.

In an example, the fuel guiding region may further comprise a second section, extending proximally from the first section, the second section being a neiloidic frustum diverging away from the first section towards a proximal end and defining a curved profile such that, together, the first and second sections define a hyperboloidal shape. In other words, the fuel guiding region may comprise a hyperboloidal portion, for example with a wider distal end and a narrower proximal end.

Optionally, the fuel guiding region further comprises a third section, extending proximally from the proximal end of the second section, the third section having a conic shape tapering inwardly towards the longitudinal axis away from the second section.

The curved profile of the second section of the fuel guiding region may, for example, be shaped to guide fuel into the first row of openings, for example when the valve needle is lifted above the threshold needle lift height. The fuel guiding region may, for example, further comprise one or more recessed grooves, extending along the second section to define respective channels for fuel delivery to the second row of openings. In this manner, a portion of the fuel can effectively bypass the curved profile of the second section of the fuel guiding region and flow through the grooves towards the second row of openings.

Optionally, the one or more recessed grooves may include a respective groove for each opening on the second row of openings. Optionally, the injector nozzle may include means for rotationally fixing the valve needle in the valve bore so as to maintain the grooves in alignment with the respective openings.

In an example, the injector nozzle may include means for rotationally fixing the valve needle in the valve bore and the second and third sections of the fuel guiding region may be truncated by an end surface inclined to the longitudinal axis to bias fuel injection to an injection side of the injector nozzle.

In an example, the first set of nozzle outlets may be longer than the second set of nozzle outlets. That is, each nozzle outlet may include an outlet passage that extends from the respective opening in the sac wall, through the nozzle body, and the outlet passages of the first set of nozzle outlets may be longer than the outlet passages of the second set of nozzle outlets. For example, the first set of nozzle outlets may (each) be at least 1.5 times the length of the second set of nozzle outlets, i.e. at least 1.5 times the length of each or any one of the second set of nozzle outlets.

In this manner, the additional length provides for greater redistribution of the flow of fuel through the first set of nozzle outlets, achieving a more uniform distribution and compensating for the tighter turn that the flow of fuel makes in order to enter the first set of nozzle outlets. In turn, the increased uniformity produces a more perpendicular exit of the flow of fuel from the first set of nozzle outlets, which improves the accuracy of spray targeting. The additional length may also provide the further benefit of being easier to drill and manufacture.

Each outlet passage may, for example, extend at an inclined angle to the longitudinal axis of the injector nozzle, defining a respective spray angle.

Optionally, a thickness of the sac wall may increase distally from the tip along the longitudinal axis. In other words, the thickness of the sac wall may increase from the proximal end, at the tip, toward a distal end of the sac. The thickness of the sac wall may therefore be greater in a region where the first set of nozzle outlets are defined, than a region where the second set of nozzle outlets are defined. The varying thickness may be provided such that the first set of nozzle outlets can be formed with a greater length than the second set of nozzle outlets, For example. That is, the first set of nozzle outlets may extend through a thicker portion of the sac than the second set of nozzle outlets.

In an example, the sac may further comprise a substantially cylindrical portion that defines a throat or entry of the sac. The cylindrical portion may allow for redistribution of the flow of fuel before the fuel is turned into the first and second sets of nozzle outlets.

According to another aspect of the invention there is provided an injector nozzle of a fuel injector for an internal combustion engine. The injector nozzle comprises: a valve needle; and a nozzle body extending along a longitudinal axis from a tip, at a proximal end, to an opposing distal end for connection to the fuel injector, the nozzle body being provided with: a bore within which the valve needle is moveable; and a valve seat defined at a proximal end of the bore and transitioning into a sac that defines a sac volume. The valve needle is moveable relative to the valve seat to control fuel delivery through a set of nozzle outlets arranged in a wall of the sac so as to bias fuel injection to an injection side of the injector nozzle. Said valve needle includes a seat region and a fuel guiding region extending proximally from the seat region, wherein the fuel guiding region is truncated by an end surface inclined to the longitudinal axis, and wherein the valve needle is rotationally fixed in the valve bore so as to maintain the end surface inclined toward the injection side of the injector nozzle such that: in a non-injecting state, the seat region seats against the valve seat and the fuel guiding region extends into the sac volume, and, in an injecting state, the seat region is unseated from the valve seat and the fuel guiding region interacts with the bore to guide fuel from the valve seat to the nozzle outlets.

In this manner, the truncated surface causes the angle of turn from the fuel guiding region to also be different around the nozzle, which is suitable where the nozzle outlets extend at different angles around the nozzle to suit different mounting arrangements of the injector nozzle in an engine, i.e. non-centrally. In particular, the fuel guiding region has a non-axisymmetric shape so as to help fuel injection to a particular injection side of the nozzle.

According to yet another aspect of the invention there Is provided a gaseous fuel injector for an internal combustion engine comprising an injector nozzle as described in a previous aspect of the invention. The internal combustion engine may be a hydrogen engine, for example.

It will be appreciated that the various features of each aspect of the invention are equally applicable to, alone or in appropriate combination with, other aspects of the invention.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numbers, and in which:

FIG. 1 is a cross-sectional view of an example injector nozzle in accordance with an embodiment of the present invention;

FIG. 2 is an enlarged cross-sectional view of a tip of the injector nozzle, shown in FIG. 1, illustrated in an injecting state;

FIG. 3 is an enlarged cross-sectional view of the tip of another example injector nozzle in accordance with an embodiment of the present invention, the injector nozzle being illustrated in the injecting state;

FIG. 4 is an enlarged cross-sectional view of the tip of a further example injector nozzle in accordance with an embodiment of the present invention, the injector nozzle being illustrated in the injecting state;

FIG. 5 is an enlarged cross-sectional view of the tip of another example injector nozzle in accordance with an embodiment of the present invention, the injector nozzle being illustrated in the injecting state;

FIG. 6 is an enlarged cross-sectional view of the tip of a further example injector nozzle in accordance with an embodiment of the present invention, the injector nozzle being illustrated in the injecting state;

FIG. 7 is an enlarged cross-sectional view of the tip of the injector nozzle shown in FIG. 6, the injector nozzle being illustrated in a low lift condition;

FIG. 8 is an enlarged cross-sectional view of the tip of the injector nozzle shown in FIG. 6, the injector nozzle being illustrated in a full lift condition;

FIG. 9 is an enlarged cross-sectional view of the tip of another example injector nozzle in accordance with an embodiment of the present invention, the injector nozzle being illustrated in the injecting state;

FIG. 10 is an enlarged cross-sectional view of the tip of a further example injector nozzle in accordance with an embodiment of the present invention, the injector nozzle being illustrated in the injecting state;

FIG. 11 is an enlarged cross-sectional view of the tip of another example injector nozzle in accordance with an embodiment of the present invention, the injector nozzle being illustrated in the injecting state;

FIG. 12 is an enlarged cross-sectional view of the tip of a further example injector nozzle in accordance with an embodiment of the present invention, the injector nozzle being illustrated in the injecting state;

FIG. 13 is an enlarged cross-sectional view of the tip of another example injector nozzle in accordance with an embodiment of the present invention, the injector nozzle being illustrated in the injecting state;

FIG. 14 is an enlarged cross-sectional view of the tip of a further example injector nozzle in accordance with an embodiment of the present invention, the injector nozzle being illustrated in the injecting state; and

FIG. 15 is an enlarged cross-sectional view of the tip of another example injector nozzle in accordance with an embodiment of the present invention, the injector nozzle being illustrated in the injecting state.

In the following description, directional or relative references such as ‘upper’, ‘lower’, ‘above’ and ‘below’, relate to the orientation of the features as illustrated in the drawings, but such references are not to be considered limiting. The skilled reader will appreciate that fuel injectors and/or injector nozzles in accordance with embodiments of the invention may be oriented differently to the manner depicted in the drawings in practice.

### DETAILED DESCRIPTION OF EMBODIMENTS OF THE INVENTION

Embodiments of the present invention relate to an injector nozzle of a fuel injector for an internal combustion engine, such as a hydrogen engine. As is conventional, the injector nozzle features a valve needle and a nozzle body, extending along a longitudinal axis from a tip, at a proximal end, to an opposing distal end that connects to an injector body, i.e. a body of the fuel injector. The nozzle body includes a bore, within which the valve needle is moveable, and a valve seat, defined at a proximal end of the bore, transitioning into a sac defining a sac volume that fills with fuel as soon as the valve needle moves away from the valve seat.

Advantageously, in order to maximise the fuel delivery, and distribute fuel evenly around the combustion cylinder, the injector nozzle includes a first set of nozzle outlets, defining a first row of openings in a wall of the sac, and a second set of nozzle outlets, defining a second or lower row of openings in the sac wall. With this arrangement the nozzle outlets can be distributed around the sac in a balanced manner, collectively providing a large flow area into the combustion chamber.

Additionally, in embodiments of the present invention, the valve needle is also configured to provide various advantages in this context. In particular, the valve needle includes a seat region for sealing the fuel injector in a non-injecting state by engaging the valve seat of the nozzle body, and a fuel guiding region that extends proximally from the seat region for guiding fuel toward, and through, the nozzle outlets when the valve needle is lifted away from the valve seat in an injecting state. In this manner, the fuel guiding region acts to redirect, or turn, fuel flowing past the valve seat toward the nozzle outlets, guarding against fuel flow instability, particularly at low and intermediate needle lift heights. This is important because some nozzles are known to exhibit a hydrodynamic phenomenon sometimes known as ‘flow transition’ at low and intermediate needle lift heights, typically between 15 to 35% of maximum lift. This transition phenomenon occurs where the fuel flow tends to follow or ‘stick’ to the surface of the valve needle at very low lifts and then abruptly switches over to follow or ‘stick’ to the sac wall surface as the valve needle lifts further away from the valve seat. The degree of sac turbulence increases where the fuel is required to change direction to a greater degree as it flows from the valve seat into the sac volume, compared to injection nozzles in which this angle is less severe, as is often the case for gaseous fuel injectors. So, it is in the context of a fuel injector nozzle having the above parameters that the present invention is particularly beneficial, since the fuel guiding region is able to counteract such effects.

It is envisaged that the injector nozzle will therefore provide a nozzle optimised for delivering gaseous fuels, such as hydrogen, to an internal combustion engine. Such an approach is also particularly useful if the nozzle is operated by a direct acting solenoid injector, where the available force is limited, since the injector nozzle provides a high flow area for operation at low pressure whilst trying to minimize the forces needed to operate it at high pressure. For this reason, the injector nozzle design can also be used for liquid fuels at higher pressures, and will enable a direct acting solenoid injector to work with a very small, and therefore low force, nozzle (i.e. a nozzle having a small valve seat diameter).

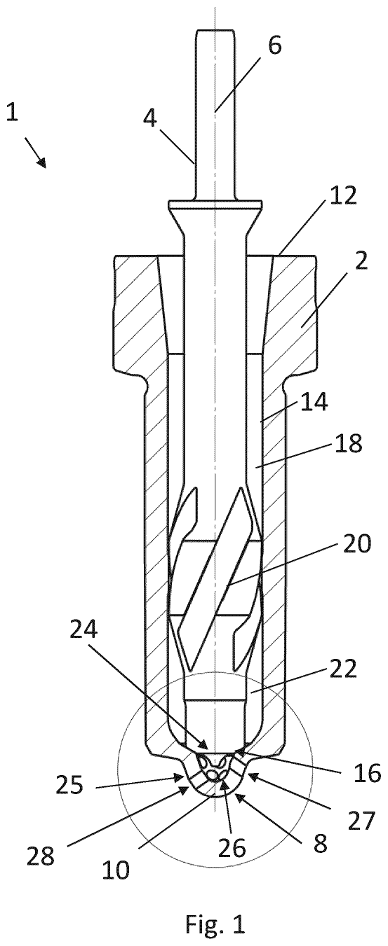

The injector nozzle shall now be discussed in more detail with reference to the example embodiments shown in FIGS. 1 to 15.

FIG. 1 shows an injector nozzle 1 comprising a nozzle body 2 and a generally cylindrical valve needle 4. The injector nozzle 1 extends along a longitudinal axis 6 from a tip 8, at a proximal end 10, to an opposing distal end 12 that connects to an injector body (not shown) of the fuel injector (not shown). In examples, it is anticipated that the injector nozzle 1 will be used in conjunction with a gaseous fuel injector, such as a hydrogen fuel injector, however this should not be considered limiting on the scope of the invention.

The valve needle 4 is slidable within a cylindrically-shaped blind bore 14 provided in the nozzle body 2. The bore 14 extends along the longitudinal axis 6 from the distal end 12 of the nozzle body 2 to the tip 8 at the proximal end 10. The valve needle 4 is movable axially to engage with, and disengage from, a valve seat 16 defined by the blind end of the bore 14, thereby controlling fuel delivery into a combustion chamber (not shown) into which the injector nozzle 1 protrudes, in use.

The valve needle 4 may be moved toward and away from the valve seat 16 under the control of an injection control valve arrangement (not shown). For example, in the context of a fuel injection system for a hydrogen engine, it is a particular advantage of the invention that the nozzle can be used in direct-acting piezoelectric injectors, where the piezoelectric actuator controls movement of the valve needle 4 through a direct action, either via a hydraulic or mechanical amplifier or coupler, or by other direct connection means. Alternatively, the valve needle 4 may be moveable by an electromagnetic arrangement or simply by way of hydraulic forces causing the valve needle to lift from its seat, both techniques of controlling valve needle movement being understood by the skilled person.

The bore 14 is shaped to define a chamber 18 to which fuel is delivered under high pressure, in use. Fuel delivered to the chamber 18 is able to flow through flats, grooves or flutes 20 provided on the surface of the valve needle 4 into a delivery chamber 22 defined between the valve needle 4 and the bore 14.

At a lower or proximal end of the valve needle 4, the valve needle 4 includes a generally conical tip section 24 that is engageable with the valve seat 16 to control fuel flow to nozzle outlets 27, 28 defined at the tip 8 of the nozzle body 2.

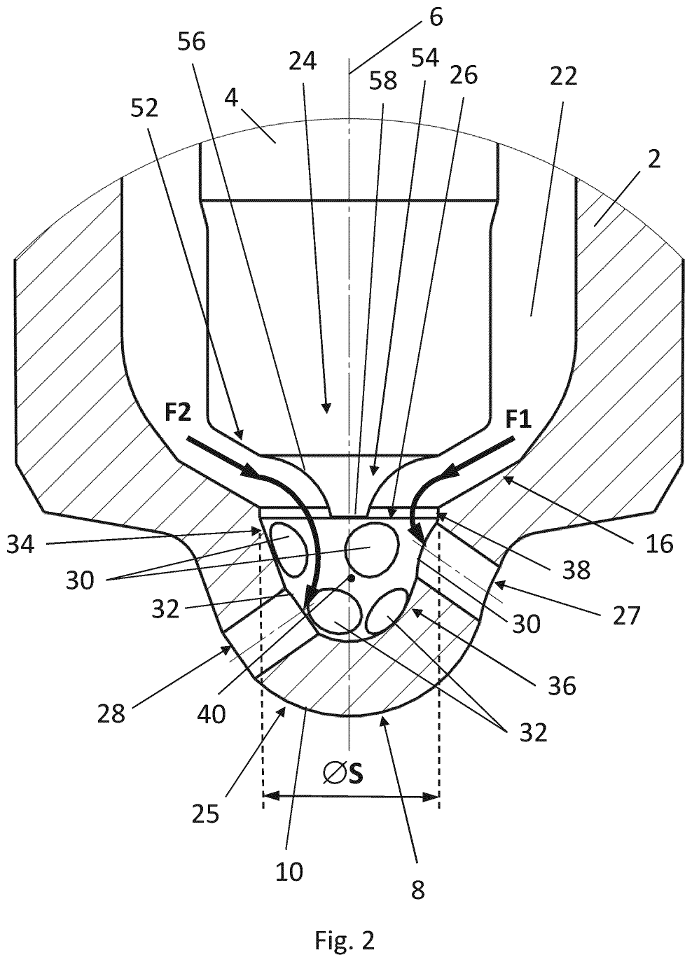

Referring to FIG. 2, which shows an enlarged cross-sectional view of the tip 8 of the nozzle body 2, the valve seat 16 is generally conical in form and defines a cone angle (i.e. an angle between diametrically opposed surfaces of the valve seat) of approximately 120 degrees in this example.

Towards the tip 8 of the nozzle body 2, the valve seat 16 then transitions into steeply sloped walls of a sac 25 defining a collection bowl or chamber into which the fuel flows from the delivery chamber 22. In particular, the sac 25 defines a sac volume 26 at the end of the bore 14 and fuel flows from the delivery chamber 22 along an annular path defined between the valve needle 4 and the valve seat 16 into the sac volume 26. The fuel subsequently flows through the sac volume 26 and into respective nozzle outlets 27, 28 at the tip 8 of the nozzle body 2.

As shown in FIG. 2, in embodiments of the present invention, the outlets 27, 28 of the injector nozzle 1 include a first set of nozzle outlets 27 and a second set of nozzle outlets 28 through which fuel flows into the combustion chamber (not shown), in use. The first set of nozzle outlets 27 define a first row of opening(s) 30 in a wall of the sac 25 and the second set of nozzle outlets 28 define a second row of opening(s) 32 in the sac wall. Each nozzle outlet 27, 28 includes a respective outlet passage that extends from a respective opening 30, 32 in the sac wall, through the nozzle body 2, at an inclined angle to the longitudinal axis 6 of the injector nozzle 1, thereby defining a respective spray angle. In examples, the spray angles may differ between the first and second sets of nozzle outlets 27, 28, for example with the second set of nozzle outlets 28 having a shallow spray angle compared to the first set of nozzle outlets 28.

It should be noted that although the term ‘set’ is used here as referring to a plurality of nozzle outlets, and although a plurality of openings are shown on each of the first and second rows 30, 32 in FIG. 1 (which is typical in practical applications), the skilled person would appreciate that the term also encompasses a single nozzle outlet, such that the first and second sets of outlets may define a single opening on each row 30, 32.

As shown in FIG. 2, the first row of openings 30 are defined in a wall of a first sac portion 34, having a frusto-conical shape in this example, and the second row of openings 32 are defined in a wall of a proximal or lower second sac portion 36, having a spherical shape in this example. This arrangement ensures that the size of the sac 25, and in turn, the diameter of the valve seat 16, may be minimised whilst ensuring adequate supply of fuel to the combustion chamber, as shall be described in more detail. However, it shall be appreciated that the first and second sac portions 34, 36 may have other suitable shapes for this purpose that converge inwardly to define a collection bowl.

The sac 25 may therefore be composed of the first sac portion 34, the second sac portion 36 and a third sac portion 38, which defines a throat or entry of the sac 25 and has a cylindrical shape, in this example, that extends steeply (and substantially axially) from the valve seat 16. In this manner, the third sac portion 38 defines a separate and distinct wall from the conical valve seat 16, and the diameter of the third sac portion 38 defines the sac throat OS. As shown in the example in FIG. 2, the first sac portion 34 extends proximally, towards the tip 8, from the third sac portion 38, tapering inwardly and the second sac portion 36 extends from a proximal end of the first sac portion 34, providing a lower spherical cap to the sac 25.

In this example, to fit the nozzle outlets 27, 28 into the smallest sac 25 possible, the first row of openings 30 may be arranged in planar alignment such that their distal edges, i.e. their uppermost edges in FIG. 2, are aligned in the same plane at, or near, a distal or upper end of the first sac portion 34.

Additionally, to prevent the second row of openings 32 interfering with the first row of openings 30, the second row of openings 32 may be arranged circumferentially between adjacent openings of the first row of openings 30, as shown in FIG. 2, and/or the second row of openings 32 may be arranged such that the second set of nozzle outlets 28 define respective outlet passages having axes that intersect at a common intersection point 40. Advantageously, if this intersection point 40 is coincident with or near the centre point of the second sac portion 36, i.e. a spherical centre point, the outlet passages of the second set of nozzle outlets 28 can have similar lengths, which is advantageous for balancing the flow of fuel between the outlets 28.

It should be noted that the configuration and shape of the tip section 24 of the valve needle 4 is also critically important to the function of the injector nozzle 1 in this respect and relatively minor structural variations can have a significant impact on the ability of the injector nozzle 1 to delivery fuel sprays accurately and repeatedly at a range of frequencies (for example between 5 and 200 injection events per second).

In this context, referring to the tip section 24 of the valve needle 4 in more detail, the valve needle 4 includes a seat region 52, having a frustoconical form in this example, that is engageable with the valve seat 16 to control fuel flow to the nozzle outlets 27, 28. The frustoconical shape of the seat region 52 is not intended to be limiting on the scope of the invention though and, in other examples, the seat region 52 may take a partially spherical form to engage the frustoconical valve seat 16 with lower contact stress, thereby reducing seat wear. Excessive wear of the valve seat 16 can be a problem for gaseous fuel injectors, such as hydrogen fuel injectors, as gaseous fuels such as hydrogen have limited or negligible lubricating properties.

Importantly, the valve needle 4 also includes a fuel guiding region 54 that extends proximally from the seat region 52, defining an end part of the valve needle 4 in a downstream area of the injector nozzle 1. When the valve needle 4 is moved away from the valve seat 16, the fuel guiding region 54 is configured to redirect, or turn, fuel flowing past the valve seat 16 toward the nozzle outlets 27, 28, and the fuel guiding region 54 therefore interacts with the bore 14 of the nozzle body 2 to encourage respective flow paths to the first set of nozzle outlets 27 and the second set of nozzle outlets 28, as shall be described in more detail.

For this purpose, the fuel guiding region 54 has a relatively wide diameter at the transition from the seat region 52 and tapers inwardly to define a curved and concave outer surface 56, in this example, terminating at a substantially flat end face 58 oriented normal to the longitudinal axis 6. Expressed another way, the geometric shape of the fuel guiding region 54 is neiloidic in form in this example, i.e. having the shape of a neiloid frustum. The end face 58 therefore has a narrower diameter than an upper part of the fuel guiding region 54 due to the curvilinear taper of the outer surface 56.

It is notable that, in this embodiment, the profile of the curved surface 56 is substantially vertical (in the orientation shown in the drawings) at the point it meets the end face 58.

However, as shall be explained in more detail, this is not essential to the inventive concept and the radius of curvature of the surface 56 may be selected so that the surface 56 defines an oblique angle with the end face 58.

The valve needle 4 is moveable axially, along the longitudinal axis 6 of the nozzle body 2, so as to control the flow of fuel injected through the nozzle outlets 27, 28 depending on whether the valve needle 4 is engaged with or disengaged from the valve seat 16. In use, as the valve needle 4 is moved upwardly, in the orientation shown in FIG. 2, the tip section 24 disengages the valve seat 16 so that high pressure fuel present in the delivery chamber 22 can travel past the tip section 24, into the sac volume 26 and through the nozzle outlets 27, 28. Re-engagement of the tip section 24 with the valve seat 16 closes the nozzle outlets 27, 28 thus terminating fuel injection.

Considered in more detail, in a non-injecting state, shown in FIG. 1, the seat region 52 of the valve needle 4 is engaged with the valve seat 16, sealing the delivery chamber 22 which receives a supply of fuel, such as hydrogen gas, from the fuel injector body.

In an injecting state, shown in FIG. 2, the valve needle 4 is moved axially away from the tip 8 of the nozzle body 2, such that the seat region 52 disengages the valve seat 16 and fuel flows from the delivery chamber 22 around the tip section 24 of the valve needle 4 and into the sac 25.

In doing so, the tip section 24 of the valve needle 4 interacts with the bore 14 of the nozzle body 2 to define an annular channel between outer surfaces of the valve seat 16, the seat region 52 and the fuel guiding region 54, along which the fuel is guided for entry into the sac 25. High-pressure fuel therefore flows from an upstream position in the delivery chamber 22 through the annular channel, into the sac volume 26, and exits via the nozzle outlets 27, 28. In order to reach the first and second rows of openings 30, 32, it should be appreciated that the fuel flowing through the annular channel is therefore required to change direction sharply, particularly in order to enter the first row of openings 30.

In this respect, once the fuel flows past the seat region 52, it encounters the fuel guiding region 54, the surface of which is curved so as to change the flow direction of the fuel and guide the fuel towards the first and second sets of outlets 27, 28. In particular, the curved surface 56 of the fuel guiding region 54 redirects the fuel along a peripheral, or radially outer, flow path directed towards the first row of openings 30 (as indicated by flow lines F1) and along a more central, axial, flow path directed toward the second row of opening 32 (as indicated by flow lines F2), which effectively bypasses the first row of openings 28. In this respect, the second row of openings 32 are closer to the longitudinal axis 6 of the nozzle 1 than the first row of openings 30, thus drawing the more of the flow thereto from the middle of the sac 25. By this combination of features, the sac throat is fully occupied with flowing fuel and its diameter can therefore be minimized for a given flow rate, limiting the force required from the injector to open the nozzle.

The fuel guiding region 54 is therefore shaped to turn the flow of fuel and guard against fuel flow instability, particularly at low and intermediate needle lift heights (i.e. below a threshold valve needle lift height of less than 50% of maximum lift, or typically between 15 to 35% of maximum lift). In particular, in a low lift condition, the fuel guiding region 54 provides the fuel flow with a degree of guidance so fuel is less likely to flow into the sac volume 26 in an uncontrolled manner. Flow instability at low needle lifts can occur in many different nozzle configurations, but the applicant has observed that it is most prevalent in injection nozzles where the cone angle of the valve seat is between 60 and 140 degrees and, more particularly between 90 and 140 degrees. In this context, it has been observed that the greater the cone angle of the valve seat 16, the greater the level of increased sac turbulence due to flow instability occurring at low needle lift heights since the fuel flow past the seating line and into the sac volume is required to change direction to a greater degree compared to injection nozzle in which this angle is less severe. So, it is in the context of a fuel injection nozzle having the above parameters that the present invention is particularly beneficial, since the fuel guiding region 54 interacts with the bore 14 to mitigate flow instability.

When the valve needle 4 is lifted further away from the valve seat 16, above the threshold valve needle lift height, e.g. to a full-lift position, the fuel guiding region 54 is disposed within the sac 25 and the end face 58 may be disposed in axial alignment with, or above, an upper or distal edge of the first sac portion 34 such that the first and second sets of nozzle outlets 27, 28 are disposed downstream of the fuel guiding region 54.

The sac entry path defined by the interaction of the tip section 24 of the valve needle 4 and the bore 14 is therefore configured to strike a balance between the requirements of i) ensuring that the fuel flow is not restricted by too tight a clearance between the fuel guiding region 54 and the sac wall, ii) ensuring that the fuel flow follows the curved surface 56 at low needle lifts and iii) ensuring that, at higher needle lifts, the end surface 58 does not interfere with the fuel flow into the first and second rows of openings 30, 32.

It is envisaged that the injector nozzle 1 of the present invention will therefore provide a nozzle optimised for delivering gaseous fuels, such as hydrogen, to an internal combustion engine.

It will be appreciated by a person skilled in the art that the invention could be modified to take many alternative forms to that described herein, without departing from the scope of the appended claims.

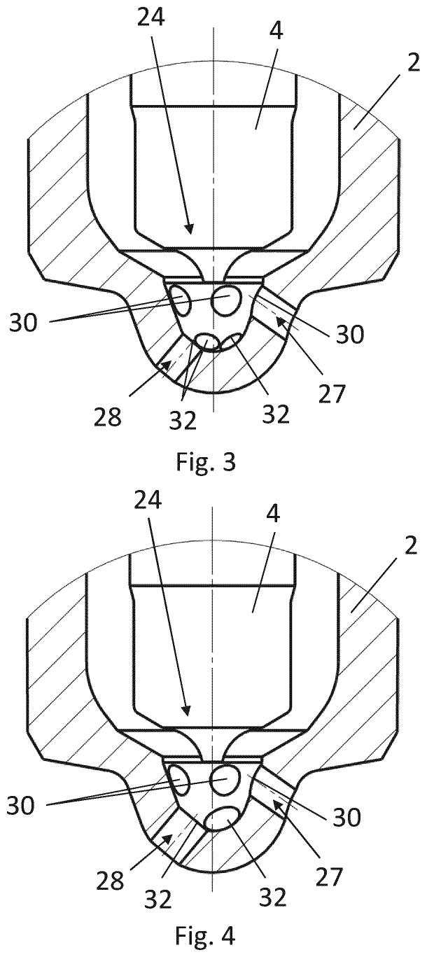

For example, FIG. 3 shows an alternative embodiment of the injector nozzle 1, in which the second row of openings 32 are smaller than the first row of openings 30. A larger diameter of the first row of openings 30 can beneficially provide a more balanced flow, particularly at full lift of the valve needle 4, with the relatively large diameters of the first row of openings 30 accommodating for the severe turn angle required for the fuel to flow into the nozzle outlets 27 of the first row of openings 30.

Additionally, where the diameters of the second row of openings 28 are relatively small, the second row of openings 32 can be arranged closer together, at a reduced radial distance from the longitudinal axis 6, without overlapping. This can provide advantages during the early stages of fuel injection, when the piston of the internal combustion engine (not shown) is lower in the engine cylinder (not shown).

For comparison, FIG. 4 shows another alternative embodiment of the injector nozzle 1, in which the second row of openings 32 are fewer in number, but equal or larger in diameter to the first row of openings 30. It shall be appreciated that this alternative arrangement can therefore provide a balanced flow rate through the first and second rows of openings 30, 32.

FIG. 5 shows a further alternative embodiment of the injector nozzle 1, in which the third sac portion 38 is lengthened to the extent that, even at low lift conditions, the end face 58 of the fuel guiding region 54 is above or distal from the first and second sac portions 34, 36 such that the flow of fuel can be redistributed following the turn into the sac 25, before turning further into the first and second rows of openings 30, 32. Whilst relevant for symmetrical sprays, this is particularly the case when as illustrated, the spray angles of the nozzles outlets 27, 28 differ around the sac 25. This is usually a consequence of the injector nozzle 1 being installed in the engine at an angle and/or not in the centre of the engine cylinder.

Additionally, flow instability is more likely to occur in nozzle configurations in which the distance between the valve seat 16 and the first row of openings 30 is relatively low compared to the diameter defined by the valve needle 4 at the point where it engages the valve seat 16, i.e. the valve seat diameter. The extended third sac portion 38 shown in this example, therefore ensures that the distance between the valve seat 16 and the first row of openings 30 is large enough to allow redistribution of the flow of fuel following the turn into the sac 25, before the fuel turns into the first and second rows of openings 30, 32.

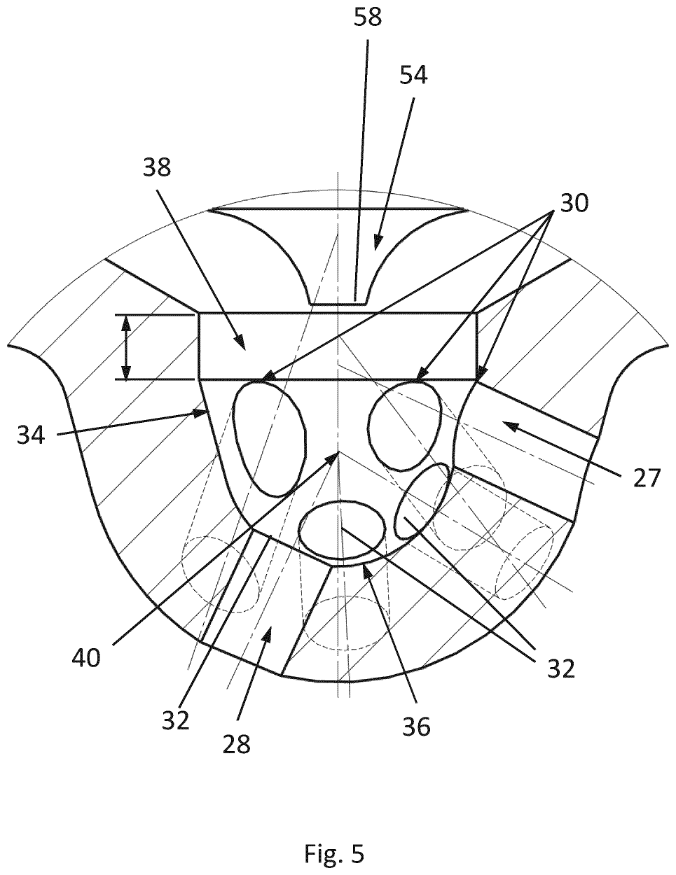

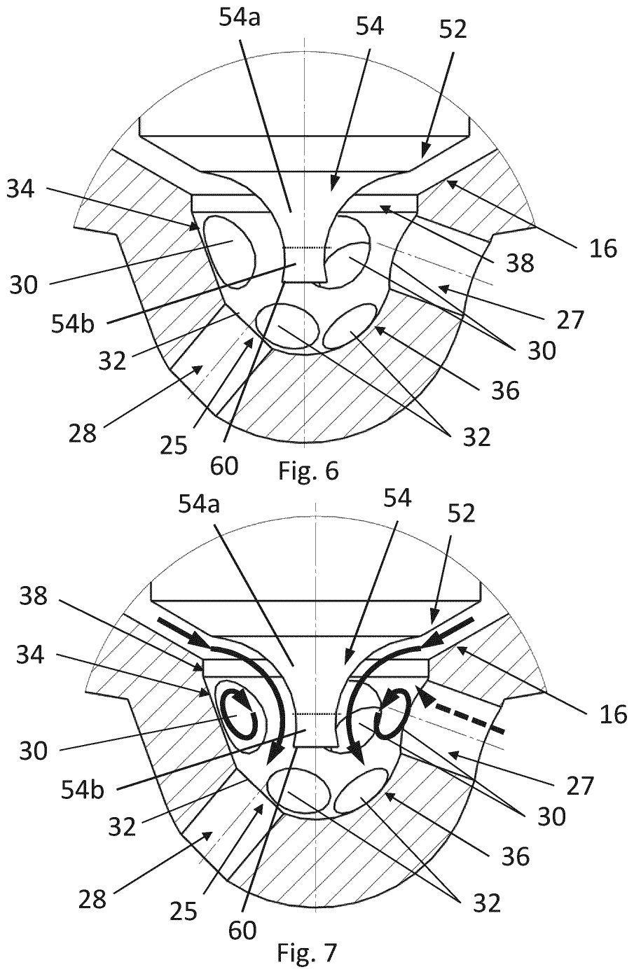

FIG. 6 shows another alternative embodiment of the injector nozzle 1, in which the fuel guiding region 54 takes a different shape to the previous examples. In particular, in this example, the fuel guiding region 54 takes a hyperboloidal shape, which may be considered to include a first section 54a having the shape of the neiloidic frustum, described in the previous examples, and a second section 54b, extending proximally from the first section, and having the shape of a neiloidic frustum that diverges away from the first section 54a towards a lower or proximal end surface 60. Together, the first and second sections 54a,b therefore define a hyperboloidal shape, having a smooth curved outer surface and terminating at the end surface 60. In the non-injecting state, the first section 54b therefore terminates between a plane defined by the centres of the first row of openings 30 and another plane defined by proximal, i.e. lower, edges of the first row of openings 30, as described in the previous example, while the second section 54b terminates proximally or below the lower edges of the first row of openings 30.

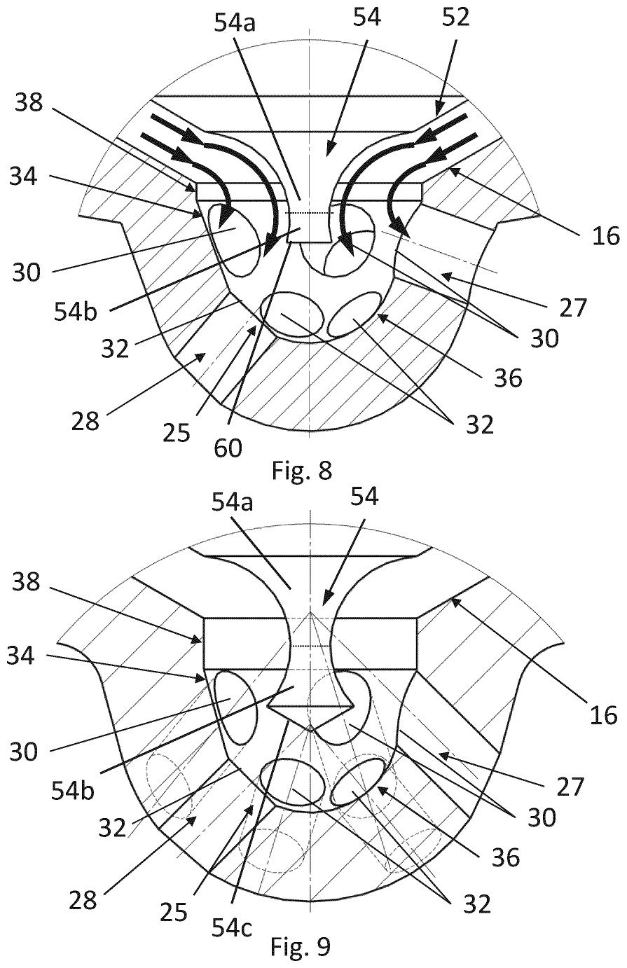

In this example, the fuel guiding region 54 is configured such that below a threshold lift height of the valve needle 4, (e.g. at less than 50% of the maximum lift, or in a low lift condition, such as between 15 to 35% of maximum lift) the second section 54b terminates between the plane defined by the centres of the first row of openings 30 and the lower edges of the first row of openings 30, as shown in FIG. 7. In these lift conditions, the fuel guiding region 54 provides a strong bias of flow to the second row of openings 32, with little or no flow of fuel to the upper first row of openings 30, which may be entirely bypassed. In this condition, it is also possible for air from the engine cylinder to be drawn into the sac 25 through the first set of outlets 27, such that the air mixes with the fuel flowing towards the second row of openings 32, as shown in FIG. 7. However, as the lift is increased, towards full lift, the fuel guiding region 54 removes the bias, providing a more equal flow of fuel between the first and second rows of openings 30, 32, as shown in FIG. 8. In particular, at full lift, the second section 54b terminates at or above the plane defined by the centres of the first row of openings 30, which provides a substantially even distribution of fuel to the first and second rows of openings 30, 32.

If each set of outlets 27, 28 are configured with varying spray angle, positioning and/or opening shape, the characteristics of the spray can be varied according to injected quantity and solenoid/actuator controls such as the rate of needle lift or the ability to maintain a partial lift. For example, the fuel injector 1 may be selectively operated in a first injection mode or a second injection mode, where the valve needle 4 may be held below the threshold lift height, in the first injection mode to provide fuel injection from the second row of openings 32, with little or no flow of fuel through the first row of openings 30, which may be entirely bypassed. In the second injection mode, the valve needle 4 may be lifted further away from the valve seat, for example to a full lift condition, such that the bias is reduced or removed to the extent that fuel flows substantially equally from the first and second rows of openings 30, 32.

FIG. 9 shows a further alternative embodiment of the injector nozzle 1, in which the fuel guiding region 54 has a hyperboloidal shape, as in the previous example, but the end of the fuel guiding region 54 is not a flat end face. Instead, the fuel guiding region 54 includes a further third section 54c extending further into the sac volume (i.e. in a downstream direction), having a conic shape, in this example, which tapers inwardly towards the longitudinal axis 6. Such a feature may be desirable in order to reduce the risk of damage to the needle 4 by reducing the sharpness of the edges. However, it should be appreciated that the third section 54c should maintain a clearance with the outlets 27, 28 so as to avoid interfering with the fuel flow into the entry openings 30, 32 at higher needle lift positions.

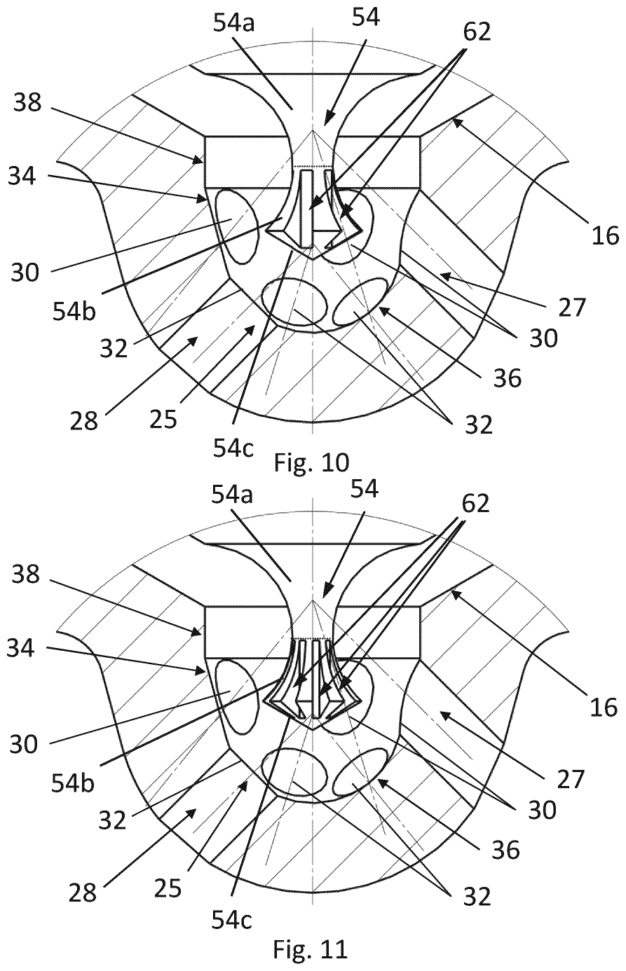

FIG. 10 shows another alternative embodiment of the injector nozzle 1, in which the fuel guiding region 54 is substantially as described in the example, shown in FIG. 9, however the hyperboloidal shape of the fuel guiding region 54 is shaped to bias the flow of fuel toward the first row of openings 30 at full lift, and the fuel guiding region 54 further includes a set of grooves 62 recessed into the lower end of the fuel guiding region 54 defining fuel channels for guiding fuel to the second row of openings 32. In particular, the curved surfaces 56 of the first and second sections 54a,b of the fuel guiding region 54 are shaped to turn the flow of fuel towards the first row of openings 30 at full lift, avoiding the second row of openings 32. However, to better balance the flow between the first and second rows of openings 30, 32, a set of grooves 62 are provided in the second and third sections 54b,c, of the fuel guiding region 54, creating flow paths directed substantially axially towards the second row of openings 32 arranged around the longitudinal axis 6 at the bottom of the sac 25, and bypassing the first row of openings 30.

As shown in FIG. 10, the set of grooves 62 may include a corresponding groove for each opening on the second row of openings 32 and the valve needle 4 may, for example, be rotationally fixed so as to maintain the grooves 62 in alignment with the respective openings 32.

Alternatively, as shown in FIG. 11, the set of grooves 62 may include a non-integer number of grooves for each opening on the second row of openings 32, for example such that ten openings draw fuel from nine grooves 62 in the fuel guiding region 54. In such examples, the valve needle 4 may be allowed to rotate, whilst minimising the variation in the total flow through the nozzle 1.

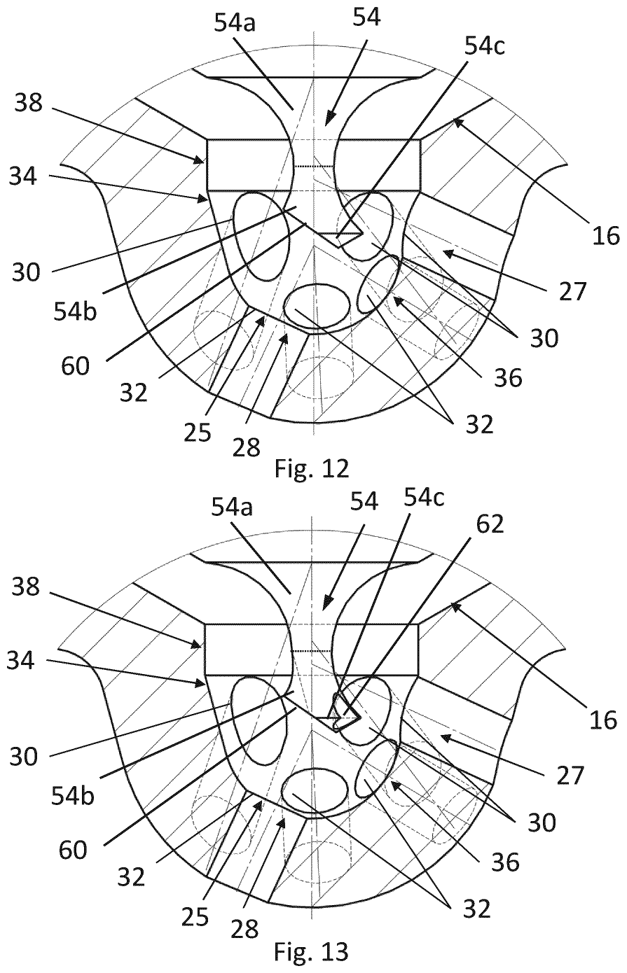

FIG. 12 shows yet another alternative embodiment of the injector nozzle 1, in which the fuel guiding region 54 is substantially as shown in FIGS. 9 to 11, but the fuel guiding region 54 is truncated by an end surface 60 inclined to the longitudinal axis 6. In particular, the second and third sections 54b,c of the fuel guiding region 54 are truncated, having a non-axisymmetric shape. This causes the angle of turn from the fuel guiding region 54 to also be different around the nozzle 1, which is suitable where the nozzle outlets 27, 28 extend at different angles around the nozzle to suit different mounting arrangements of the injector nozzle 1 in an engine, i.e. non-centrally. For example, in order to bias fuel injection to a particular injection side of the nozzle 1. In this case, needle rotational alignment would need to be fixed by suitable means. Additionally, as shown in FIG. 13, the fuel guiding region 54 may include a set of grooves 62, as described previously, for supplying fuel to some or all of the openings in the second row of openings 32, where each groove 62 may be adapted to a particular opening position and spray angle.

It shall be appreciated that the fuel guiding region 54 shown in the embodiment of FIGS. 12 and 13 is therefore also advantageous, more generally, in embodiments where the injector nozzle 1 includes a set of nozzle outlets arranged in a wall of the sac 25 to bias fuel injection to an injection side of the injector nozzle 1, without necessarily having first and second rows of openings, as in the previous examples.

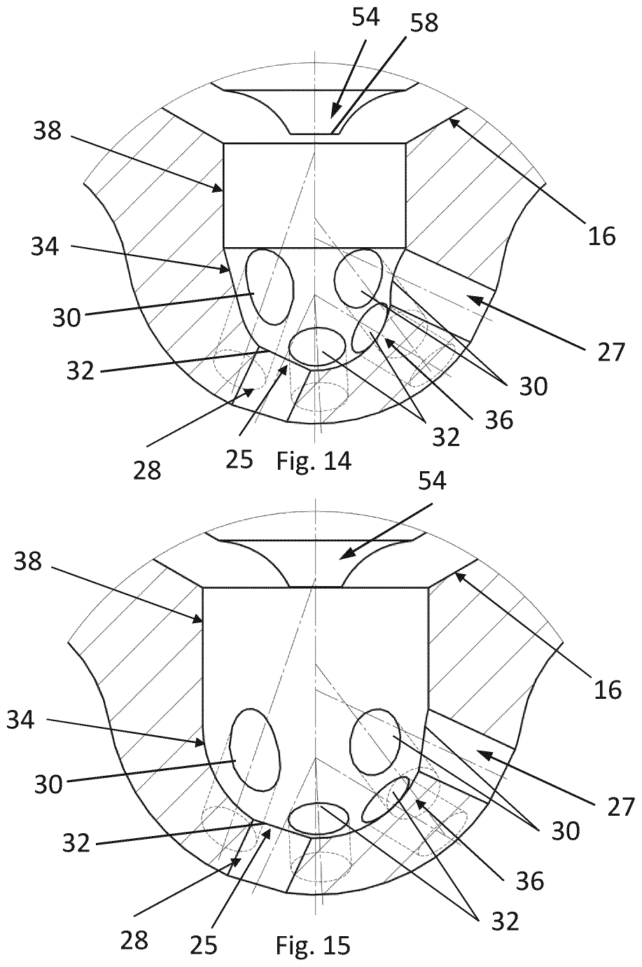

FIGS. 14 and 15 show two additional alternative embodiments of the injector nozzle 1, in which the first set of nozzle outlets 27 are longer than the second set of nozzle outlets 28. That is, the outlet passages of the first set of nozzle outlets 27 are longer than the outlet passages of the second set of nozzle outlets 28 in each example, and therefore extending a greater distance from the respective opening 30, 32 in the sac wall, through the nozzle body 2. For example, the first set of nozzle outlets 27 may be at least 1.5 times the length of the second set of nozzle outlets 28. This is facilitated by the sac wall having a varying thickness. More specifically, the thickness of the sac wall increases from the proximal end, at the tip 8, toward a distal end of the sac 25. The thickness of the sac wall is therefore greater in a region where the first set of nozzle outlets 27 are defined, than a region where the second set of nozzle outlets are defined 28.

The extended or additional length of the first set of nozzle outlets 27 compensates for the fact that the flow of fuel has to make a tighter turn in order to enter the first set of nozzle outlets 27 as compared to the second set of nozzle outlets 28. In this respect, the additional length provides for greater redistribution of the flow of fuel through the first set of nozzle outlets 27, achieving a more uniform distribution. In turn, the increased uniformity produces a more perpendicular exit of the flow of fuel from the first set of nozzle outlets 27, which advantageously improves the accuracy of spray targeting. Additionally, where the nozzle outlets are arranged substantially perpendicular to the longitudinal axis of the nozzle body, as shown in FIGS. 14 and 15, the additional length also provides the further benefit of being easier to drill and manufacture. Accordingly, the exemplary embodiments of FIGS. 14 and 15 are provided to demonstrate that the wall thickness of the sac 25 may increase away from the proximal tip 8 to ensure that the relatively distal first set of nozzle outlets 27 have a greater length than the relatively proximal second set of nozzle outlets 28.

The embodiment of the injector nozzle 1 shown in FIG. 14, is otherwise substantially identical to the embodiment previously discussed in relation to FIG. 5, and the third sac portion 38 is lengthened to the extent that the end face 58 of the fuel guiding region 54 is above or distal from the first and second sac portions 34, 36. The extended third sac portion 38 shown in this example ensures that the distance between the valve seat 16 and the first row of openings 30 is large enough to allow redistribution of the flow of fuel following the turn into the sac 25, before the fuel turns into the first and second rows of openings 30, 32.

The example embodiment shown in FIG. 15, differs from the embodiment shown in FIG. 14 in that the sac 25 has a substantially cylindrical portion that defines a throat or entry of the sac 25, which transitions into a spherical portion, in which the first and second sets of nozzle outlets 27, 28 are defined. In contrast to the previous examples, the first and second portions 34, 36 of the sac 25 therefore combine to form a single spherical sac portion, in which the first and second sets of nozzle outlets 27, 28 are arranged substantially as described previously. Overall, the shape of the sac 25 may therefore be substantially hemi-ellipsoidal and, in other examples, the first and second portions 34, 36 of the sac 25 may even combine to form a single ellipsoidal sac portion, in which the first and second sets of nozzle outlets 27, 28 are arranged, or a single spheroidal sac portion. In each of these examples, the shape of the sac 25 may require a larger diameter to accommodate the first and second sets of nozzle outlets 27, 28. Therefore, the embodiment shown in FIG. 15 is particularly suited to applications where higher actuation forces are available to operate the fuel injector at high pressure.

Any or all of the flow directing features described may be used in conjunction with tailoring the diameters of some or all of the nozzle outlets 27, 28 in order to achieve either a balanced flow, or to optimally distribute the flow within the engine cylinder.

### REFERENCES USED

1—Fuel injector
2—Nozzle body
4—Valve needle
6—Longitudinal axis (of nozzle body)
8—Tip (of nozzle body)
10—Proximal end (of nozzle body)
12—Distal end (of nozzle body)
14—Bore (of nozzle body)
16—Valve seat
18—Chamber
20—Flutes
22—Delivery chamber
24—Tip section (of valve needle)
25—Sac
26—Sac volume
27—First set of nozzle outlets
28—Second set of nozzle outlets
30—First row of openings
32—Second row of openings
34—First sac portion
36—Second sac portion
38—Third sac portion
40—Intersection point
52—Seat region (of valve needle)
54—Fuel guiding region
56—Outer surface (of fuel guiding region)
58—End face (of fuel guiding region)
60—End surface (of fuel guiding region)
62—Set of grooves

1. An injector nozzle of a fuel injector for delivering gaseous fuel to an internal combustion engine, the injector nozzle comprising:
a valve needle; and
a nozzle body extending along a longitudinal axis from a tip, at a proximal end, to an opposing distal end for connection to the fuel injector, the nozzle body being provided with:
a bore within which the valve needle is moveable; and
a valve seat defined at a proximal end of the bore and transitioning into a sac that defines a sac volume;
wherein the valve needle is moveable relative to the valve seat to control fuel delivery through a first set of nozzle outlets and a second set of nozzle outlets, the first set of nozzle outlets defining a first row of openings in a wall of the sac and the second set of nozzle outlets defining a second row of openings in the sac wall, the first row of openings being arranged distally from the second row of openings along the longitudinal axis, and
wherein said valve needle includes a seat region and a fuel guiding region extending proximally from the seat region such that:
in a non-injecting state, the seat region seats against the valve seat and the fuel guiding region extends into the sac volume, and,
in an injecting state, the seat region is unseated from the valve seat and the fuel guiding region interacts with the bore to guide fuel from the valve seat to at least one of the first and second sets of nozzle outlets.

2. An injector nozzle according to claim 1, wherein the second row of openings are arranged circumferentially between adjacent openings of the first row of openings; and/or the second row of openings are smaller, and/or fewer in number, than the first row of openings.

3. An injector nozzle according to claim 1, wherein the sac comprises a first sac portion and a second sac portion extending proximally from the first sac portion; the first row of openings being defined in a wall of the first sac portion and the second row of openings being defined in a wall of the second sac portion.

4. An injector nozzle according to claim 3, wherein the first sac portion has a frusto-conical shape and the second sac portion has a spherical shape, an ellipsoidal shape, or a spheroidal shape.

5. An injector nozzle according to claim 3, wherein the first and second sac portions define a spherical shape, an ellipsoidal shape, or a spheroidal shape.

6. An injector nozzle according to claim 3, wherein distal edges of the openings of the first row of openings are arranged in planar alignment toward a distal end of the first sac portion.

7. An injector nozzle according to claim 3, wherein the second set of nozzle outlets extend from the second row of openings along respective outlet axes that intersect at a common point in the sac volume, optionally, wherein the intersection point is coincident with a centre of curvature of the second sac portion.

8. An injector nozzle according to claim 1, wherein the fuel guiding region comprises a first section having the shape of a neiloidic frustum converging towards a proximal end and having an outer surface defining a curved profile.

9. An injector nozzle according to claim 1, wherein the fuel guiding region is shaped so as to interact with the bore in the injecting state such that: below a threshold needle lift height, the fuel guiding region biases fuel flow towards the second row of openings; and, at or above the threshold needle lift height, the fuel guiding region negates the bias, such that fuel flows towards both the first and second row of openings; optionally, wherein the threshold needle lift height is less than 50% of the maximum lift height; preferably, wherein the threshold needle lift height is less than 35% of the maximum lift height.

10. An injector nozzle according to claim 3, wherein the first section of the fuel guiding region is arranged distally of the first sac portion to guide fuel into the first and second sac portions when the valve needle is lifted above the threshold needle lift height.

11. An injector nozzle according to claim 3, wherein the fuel guiding region further comprises a second section, extending proximally from the first section, the second section being a neiloidic frustum diverging away from the first section towards a proximal end and defining a curved profile such that, together, the first and second sections define a hyperboloidal shape.

12. An injector nozzle according to claim 11, wherein the fuel guiding region further comprises a third section, extending proximally from the proximal end of the second section, the third section having a conic shape tapering inwardly towards the longitudinal axis away from the second section.

13. An injector nozzle according to claim 11, wherein the curved profile of the second section of the fuel guiding region is shaped to guide fuel into the first row of openings when the valve needle is lifted above the threshold needle lift height, and the fuel guiding region further comprises one or more recessed grooves, extending along the second section to define respective channels for fuel delivery to the second row of openings.

14. An injector nozzle according to claim 13, wherein the one or more recessed grooves include a respective groove for each opening on the second row of openings, and wherein the injector nozzle includes means for rotationally fixing the valve needle in the valve bore so as to maintain the grooves in alignment with the respective openings.

15. An injector nozzle according to claim 12, wherein the injector nozzle includes means for rotationally fixing the valve needle in the valve bore; and wherein the second and third sections of the fuel guiding region are truncated by an end surface inclined to the longitudinal axis to bias fuel injection to an injection side of the injector nozzle.

16. An injector nozzle according to claim 1, wherein a thickness of the sac wall increases distally from the tip along the longitudinal axis.

17. An injector nozzle according to claim 1, wherein the first set of nozzle outlets are longer than the second set of nozzle outlets.

18. An injector nozzle of a fuel injector for an internal combustion engine, the injector nozzle comprising:
a valve needle; and
a nozzle body extending along a longitudinal axis from a tip, at a proximal end, to an opposing distal end for connection to the fuel injector, the nozzle body being provided with:
a bore within which the valve needle is moveable; and
a valve seat defined at a proximal end of the bore and transitioning into a sac that defines a sac volume;
wherein the valve needle is moveable relative to the valve seat to control fuel delivery through a set of nozzle outlets arranged in a wall of the sac so as to bias fuel injection to an injection side of the injector nozzle, and
wherein said valve needle includes a seat region and a fuel guiding region extending proximally from the seat region, wherein the fuel guiding region is truncated by an end surface inclined to the longitudinal axis, and wherein the valve needle is rotationally fixed in the valve bore so as to maintain the end surface inclined toward the injection side of the injector nozzle such that:
in a non-injecting state, the seat region seats against the valve seat and the fuel guiding region extends into the sac volume, and,
in an injecting state, the seat region is unseated from the valve seat and the fuel guiding region interacts with the bore to guide fuel from the valve seat to the nozzle outlets.

19. A gaseous fuel injector for an internal combustion engine comprising an injector nozzle according to claim 1, optionally, wherein the internal combustion engine is a hydrogen engine.
